(19) United States
(12) Patent Application Publication
(10) Pub. No.: US 2020/0256048 A1
(43) Pub. Date: Aug. 13, 2020

(54) Retaining Structure

(71) Applicants: Sensor (UK) Ltd., Lancanshire (GB); Carlow Precast Manufacturing ULC, Kilnock (IE); MWH UK Ltd, London (GB)

(72) Inventors: Jon CROWTHER, Manchester (GB); Colin SMITH, London (GB)

(73) Assignees: Sensor (UK) Ltd., Lancanshire (GB); Carlow Precast Manufacturing ULC, Kilnock (IE); MWH UK Ltd, London (GB)

(21) Appl. No.: 16/496,542

(22) PCT Filed: Mar. 22, 2018
(86) PCT No.: PCT/GB2018/050751

§ 371 Date: Sep. 23, 2019

(30) Foreign Application Priority Data
Mar. 23, 2017 (GB) 1704610.3

(51) Int. Cl. E04B 1/20; G01M 3/16

(52) U.S. Cl. CPC E04B 1/20; E02D 31/004; G01M 3/16

(57) ABSTRACT

A wall unit (V) for a retaining structure (100) comprises a foot portion (1a′) and a wall portion (1b′), wherein the wall portion (1b′) is inclined with respect to the foot portion (1a′), so that it extends over the foot portion (1a′). Accordingly, the wall unit (1′) is stable during construction and assembly. A corner unit (7′) for a retaining structure (100) is adapted to engage with two wall units (1′). A retaining structure (100) comprises at least one wall unit (1′).

This invention relates to a retaining structure and methods of constructing the same, a leak detection system for a retaining structure and methods of constructing the same.

### BACKGROUND

Within the construction industry there has been a drive for many years to increase offsite manufacturing whilst reducing the amount of site work required as a result. This allows for reductions in site costs and reductions in the risk of injury to site workers on multi-trade sites. This has led to the concept of using prefabricated structural elements that by their nature are then difficult to waterproof due to the arrangement of joints between sections and the potential for differential movement causing connections to become unsound at some future point.

Further difficulties arise in relation to the onsite assembly of prefabricated structural elements. For example, the prefabricated structural elements can be complicated to assemble, especially in conjunction with lining materials. Furthermore, the shape and configuration of the elements—particularly those that are substantially upstanding—renders them difficult to accurately position, and susceptible to subsequent accidental movement once positioned. Such difficulties result in lost time in construction and/or the need for specially-developed tools or devices to retain the elements in position during installation.

It is an object of the present invention to address the abovementioned disadvantages.

### SUMMARY

In order to address the disadvantages identified above, the approach has been developed to produce a retaining structure incorporating movement tolerant lining materials with prefabricated structural elements. This combination means that all waterproofing requirements for the structural element design including crack width calculations, movement and general waterproofness can be omitted as design considerations in relation to those structural elements. Furthermore the introduction of electronic leak detection and location systems into the design allows any future leakage both in or out of the fluid retaining structure to be detected, located and repaired without wholescale replacement of the waterproofing layers. In addition, the approach has been developed to include structural elements that require relatively less support during construction, and which are securable in a manner that avoids differential movement causing connections to become unsound at some future point

According to the present invention there is provided an apparatus and method as set forth in the appended claims. Other features of the invention will be apparent from the dependent claims, and the description which follows.

According to a first aspect of the present invention, there is provided a wall unit for a retaining structure, comprising a foot portion and a wall portion, wherein the wall portion is inclined with respect to the foot portion, so that it extends over the foot portion.

The wall portion may extend upwardly from the foot portion. The wall portion may be inclined with respect to the foot portion so that an acute angle is formed between the wall portion and the foot portion. The angle formed between the wall portion and the foot portion may be in the range of 55-85°. The acute angle may be formed on an interior side of the wall unit, which preferably forms the interior of the retaining structure. The acute angle may be measured from a major axis of the wall portion to a major axis of the foot portion. The wall portion may extend upwardly from one end of the foot portion, preferably an outermost end, preferably with respect to the interior of the retaining structure. The wall portion may comprise an exterior face, preferably forming the exterior of the retaining structure, and the foot portion may be arranged not to extend beyond the exterior face. The wall portion may be inclined at an acute angle, preferably in a range of 5°-35°, from a vertical plane extending upwards from the foot portion.

The wall portion may be thicker at a lower end thereof than an upper end thereof, wherein the lower end is closer to the foot portion than the upper end. A thickness of the wall portion may reduce as extends away from the foot portion.

The foot portion may be thicker at an outermost end thereof than an innermost end thereof, wherein the outermost end thereof is closer to the wall portion than the innermost end thereof. A thickness of the foot portion may reduce as it extends away from the wall portion. The foot portion, preferably an underside thereof, may be arranged to contact the ground. The foot portion may comprise an upper surface, which may slope downwardly as it extends away from the wall portion. The innermost end of the foot portion may form a toe portion arranged to engage with a floor of the retaining structure.

The distance between an innermost and an outermost end of the foot portion and the distance between a lower end and an upper end of the wall portion may be in the range of 6:1-3:1, preferably 4:1-5:1, preferably approximately 4.5:1.

The wall unit may comprise an anchorage point, preferably a stressing head, configured to receive a tendon. The stressing head may be located proximate to the lower end of the wall portion, such that the tendon extends through the foot portion and/or a floor of the retaining structure. The stressing head may be located proximate to the upper end, so that the tendon extends through a roof of the retaining structure. Each wall unit may comprise two stressing heads, respectively located proximate to the lower and upper end of the wall.

The wall portion and the foot portion may be integrally formed, preferably of precast concrete.

According to a second aspect of the invention there is provided a corner unit for a retaining structure, adapted to engage with two wall units of the first aspect.

The corner unit may comprise a first wall arranged to engage with a first of the two wall units, and a second wall arranged to engage with a second of the two wall units. The first wall may extend, preferably substantially orthogonally, from the second wall.

The first wall and second wall may reduce in thickness from a lower end to an upper end thereof, wherein an angle of taper corresponds to an inclination of the wall portion of the wall units with respect to the foot portion of the wall units.

The corner unit may comprise an anchorage point, preferably a stressing head, configured to receive a tendon. Each of the first and second walls may comprise a stressing head, configured to receive a tendon extending through a corresponding wall unit. The stressing head may be located proximate the lower end of the wall portion, such that the tendon extends through the foot portion of the corresponding wall unit. The stressing head may be located proximate the upper end, so that the tendon extends through a roof of the retaining structure and/or an upper portion of the corresponding wall unit. Each wall may comprise two stressing heads, respectively located proximate the lower and upper end of the wall.

According to third aspect of the invention there is provided a retaining structure comprising at least one wall unit as defined in the first aspect.

The retaining structure may comprise a sidewall comprising a plurality of wall units.

The retaining structure may comprise at least two adjacent sidewalls and a corner unit as defined in the second aspect disposed between the adjacent sidewalls.

The retaining structure may comprise a pair of opposing sidewalls and a floor extending therebetween. The floor may be comprised of a plurality of preformed floor units, preferably formed of precast concrete. The retaining structure may comprise a tendon extending from a wall unit of a first of the opposing sidewalls, through the floor, and to a corresponding wall unit of a second of the opposing sidewalls. Alternatively, the tendon may extend to an internal dividing wall of the retaining structure. The tendon may be operable to be tightened once installed. Advantageously, the tightened tendon restrains the wall units and floor, thereby reinforcing the floor and/or preventing movement of the wall units caused by hydrostatic pressure.

The retaining structure may comprise a roof, extending between a pair of opposing sidewalls. The roof may comprise a plurality of elongate beams, wherein each end of the beam comprises an engagement portion adapted to engage one of the wall units or an internal dividing wall of the retaining structure. The engagement portion may be a corbel. A pair of adjacent beams may be adapted to retain a roof unit, preferably a roof plate, therebetween. Each of the adjacent beams may comprise a projection, preferably a shelf, arranged to retain the roof unit. The retaining structure may comprise a tendon extending from a wall unit of a first of the opposing sidewalls, through the roof, and to a corresponding wall unit of a second of the opposing sidewalls. Preferably, the tendon is arranged to restrain the wall units against lateral displacement under internal pressure. The retaining structure may comprise a roof screed, preferably disposed above the beams and roof units. The tendon may extend through the screed. The screen may retain the tendon in an at least partially curved configuration, preferably around one or more openings in the roof.

The retaining structure may be a fluid retaining structure, preferably a service reservoir or a tank. The retaining structure may be one of a bridge abutment, aggregate store, retaining wall, blast wall, embankment or superstructure.

According to a fourth aspect of the invention there is provided a retaining structure comprising:
a pair of opposing sidewalls, each sidewall comprising a plurality of wall units, and
a floor extending between the opposing sidewalls,
wherein the retaining structure further comprises a tendon extending from a first wall unit of a first of the opposing sidewalls, through the floor, and to a corresponding second wall unit of a second of the opposing sidewalls, the tendon being operable to be tightened once installed so as to restrain the first and second wall units and the floor.

According to a fifth aspect of the invention there is provided a method of constructing a retaining structure comprising:
forming a pair of opposing sidewalls from a plurality of wall units,
disposing a floor between the opposing sidewalls, and
tightening a tendon extending from a first wall unit of a first of the opposing sidewalls, through the floor, and to a corresponding second wall unit of a second of the opposing sidewalls.

The invention also extends to a kit of parts comprising a plurality of wall units, a floor and a tendon as defined in the fourth aspect. Preferably, the wall unit is as defined in the first aspect. The kit may further comprise a corner unit as defined in the second aspect.

According to a further aspect of the present invention, there is provided a fluid retaining structure having an electronic leak detection and location, ELDL, system, wherein the fluid retaining structure comprises inner and outer liners that form electrical isolation layers of the ELDL system, wherein an electrically conductive signal layer of the ELDL system provides structural rigidity to the fluid retaining structure.

Preferably, the electrical isolation layers are adapted to perform fluid retention and ingress prevention functions of the fluid retaining structure.

Preferably the liners are waterproofing liners.

The electrically conductive signal layer may be made of a concrete-based material. The electrically conductive signal layer may be reinforced with a metal, such as steel or other materials that enhance structural capacity of the concrete. The electrically conductive signal layer may be reinforced with a plurality of metal or other elements that are in electrical contact with each other.

Advantageously the concrete provides both an electrically conducting layer for the ELDL system and the structural integrity to support the fluid retaining structure whilst the electrical isolation layers retain fluid therein and prevent fluid from outside entering the structure.

A floor section of the outer liner may be located beneath a floor section of the electrically conductive signal layer. The floor section of the electrically conductive signal layer may be a steel reinforced concrete floor.

Uniquely the floor section of the electrically conductive signal layer of the fluid retaining structure may be entirely, or substantially, constructed of interlocking precast concrete units that may or may not require tying together with structural ties, equally for the purposes of the ELDL system the floor section of the electrically conductive signal layer could be in situ cast concrete.

Wall sections of the outer liner are preferably continuous with the floor section thereof. The wall sections of the outer liner are preferably wrapped around wall sections of the electrically conductive signal layer.

The wall sections of the electrically conductive signal layer may be steel reinforced concrete wall sections and may be the structural element of fluid retaining walls. The wall sections of the electrically conductive signal layer may be electrically isolated from each other. One wall section of the electrically conductive signal layer may be electrically isolated from an adjacent wall section of the electrically conductive signal layer. The electrical isolation is to sufficient allow signals from adjacent wall sections of the electrically conductive signal layer to be distinguished from each other.

At least one of the wall sections of the electrically conductive signal layer may incorporate cavities, preferably introduced during manufacture. The cavities may be side cavities that preferably extend inwards from side edges of the wall sections of the electrically conductive signal layer. The cavities may be longitudinally tapered. The cavities may be rectilinear, preferably square, in cross-section. The cavities may have the advantageous effect of reducing an amount of concrete used in the wall sections. The wall sections of the electrically conductive signal layer may advantageously incorporate gaps therebetween to allow for the drainage of a leachate. Electrical connections to the control means of the ELDL system may also pass between the wall sections.

The wall sections of the outer liner preferably extend and/or wrap over an upper edge or wall plate of the wall section of the electrically conductive signal layer.

The outer liner is preferably welded to the inner liner such that it passes through a wall roof joint of the electrically conductive signal layer. However there are other configurations possible where the inner liner is not connected to the outer liner and instead remains separate.

The fluid retaining structure may include internal column supports. The internal column supports may be located inside cover elements of the inner liner. The cover elements may be sleeves placed over the column supports. The cover elements may be joined to or part of a floor section of the inner liner. The floor section of the inner liner is preferably located over a floor section of the fluid retaining structure. The cover elements may be welded to the floor section of the inner liner.

The fluid retaining structure may include a roof. The roof may be supported by the internal column supports and the wall sections. The roof may or may not also be an element of the electrically conductive signal layer.

The outer liner may be wrapped over the roof, whereupon it would be necessary to line the soffit of the roof with the inner liner in the same way as the floor. Alternatively the roof liner may have a dual liner system with conductive medium and sensors between where the lower and upper liners would preferably be welded to the outer liner below the wall roof joint, forming a separate ELDL zone.

The fluid retaining structure preferably presents only the inner liner to any contents of the fluid retaining structure. The inner liner preferably prevents any fluid held in the fluid retaining structure from contacting the electrically conductive signal layer in the absence of a leak.

Sensors of the ELDL system are preferably located between the inner and outer liners. The sensors may be located in electrical contact with the electrically conductive signal layer. The sensors may be located in openings in the electrically conductive signal layer.

Wiring of the ELDL system preferably exits the electrically conductive signal layer at an upper section of the fluid retaining structure.

The inner and/or outer liners may be made of sections of non-electrically conducting liner material that are secured together, preferably by welding.

According to another aspect of the present invention there is provided a two layer electronic leak detection and location, ELDL, system comprising inner and outer liners and an electrically conductive signal layer comprising sensors, wherein the electrically conductive signal layer provides structural rigidity to allow the ELDL system.

Preferably, the electrically conductive signal layer provides the electrical conductivity between the two liners necessary to allow the ELDL system to function.

The ELDL system may include control means and a plurality of sensors, wherein the sensors are electrically isolated from each other and in electrical communication to the control means, wherein the sensors have a sheet form. In this case, each sensor may be a wall section of the electrically conductive signal layer.

The sensors may be block sensors or tile sensors.

The sensors may be physically connected to each other, albeit electrically isolated from each other. The sensors may be physically joined by a non-conducting material, which may form a welded joint between sensors.

The sensors may be spaced from each other to leave a gap therebetween, which gap is electrically non-conducting.

The electrical communication with the control means may be a wired or wireless communication.

According to a another aspect of the present invention, there is provided a method of retaining a fluid in a structure, the structure having an electronic leak detection and location, ELDL, system, wherein the fluid is retained by an inner liner that forms an electrical isolation layer of the ELDL system, wherein an electrically conductive signal layer of the ELDL system provides structural rigidity to the fluid retaining structure.

According to another aspect of the present invention, there is provided kit of parts for a fluid retaining structure having an electronic leak detection and location, ELDL, system, wherein the fluid retaining structure comprises inner and outer liners for forming electrical isolation layers of the ELDL system, wherein an electrically conductive signal layer of the ELDL system provides structural rigidity to the fluid retaining structure.

According to another aspect of the present invention, there is provided a liner for a fluid retaining structure having an electronic leak detection and location, ELDL, system, wherein the liner is adapted to form an electrical isolation layer of the ELDL system.

According to another aspect of the present invention, there is provided a fluid retaining structure adapted to incorporate an electronic leak detection and location, ELDL, system, wherein structural elements of the fluid retaining structure are adapted to form an electrically conductive signal layer of the ELDL system.

The references to service reservoir herein should be interpreted to include waste water tanks also.

All of the features described herein may be combined with any of the above aspects, in any combination.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic perspective view of a water impermeable outer geomembrane with a service reservoir floor slab structure laid thereon;

FIG. 2 is a schematic perspective view of geomembrane and floor slab with some wall units of the service reservoir in position;

FIG. 3 is a schematic perspective view of the structure of FIG. 2 with metal tie bars in position, with the geomembrane omitted for clarity;

FIG. 4 is a schematic perspective view of the structure of FIG. 3 with a second layer of floor slabs in position;

FIG. 5 is a schematic perspective view of the structure of FIG. 4 with support columns of the service reservoir in position;

FIG. 6 is a schematic perspective view of the structure of FIG. 5 with beams located on the support columns of the service reservoir;

FIG. 7 is a schematic perspective view of the structure of FIG. 6 with metal roof ties of the service reservoir in position;

FIG. 8 is a schematic perspective view of the structure of FIG. 7 with some roof slabs of the service reservoir in position;

FIG. 9 is a schematic perspective view of the structure of FIG. 8 with additional roof slabs of the service reservoir in position and the outer geomembrane in position;

FIG. 10 is a schematic partial perspective view of the floor slab showing positions of the columns;

FIG. 11 is a schematic partial perspective view showing roof/wall joints of the service reservoir;

FIG. 12 is a schematic partial perspective cut-away view showing the wall/roof structure;

FIG. 13 is schematic partial perspective cut-away view showing a corner of the service reservoir;

FIG. 14 is a schematic partial eye level perspective view of the service reservoir;

FIG. 15 is a schematic partial perspective cut-away view showing ends of the beams;

FIG. 16 is schematic partial perspective cut-away view showing details of the floor slabs and tie bars;

FIGS. 17a-c show schematic front, rear and cross-sectional views of an embodiment of wall section for the service reservoir;

FIG. 18 is a perspective view of a retaining structure according to an example of the invention;

FIG. 19 is a cross-sectional view of the retaining structure of FIG. 18;

FIG. 20A-D show schematic side views of exemplary wall units of the retaining structure of FIGS. 18 and 19;

FIG. 21 is a partial schematic plan view of the retaining structure of FIGS. 18-20;

FIG. 22 is a schematic perspective view of an exemplary corner unit of the retaining structure of FIGS. 18-21;

FIG. 23A-D show perspective, longitudinal cross-sectional, transverse cross-sectional and plan views of an exemplary suspension beam roof support of the retaining structure of FIGS. 18-22; and

FIG. 24A-D show perspective, front, plan and cross-sectional views of the exemplary wall units of the retaining structure of FIGS. 18-23.

### DETAILED DESCRIPTION

The fluid retaining structures described herein are exemplified with respect to a service reservoir for drinking water as an example. Other fluid retaining structures are eminently suited to the invention, including slurry tanks, waste water reservoirs, water treatment reservoirs and generally tanks or retaining structures to keep fluids isolated from a surrounding environment. In addition it is conceived that the fluid retaining structure might also be used to create dry storage environment or dry underground accommodation where watertightness of the structure is paramount and monitorable, for example underground data centres or dry storage of contaminated wastes, such as nuclear wastes.

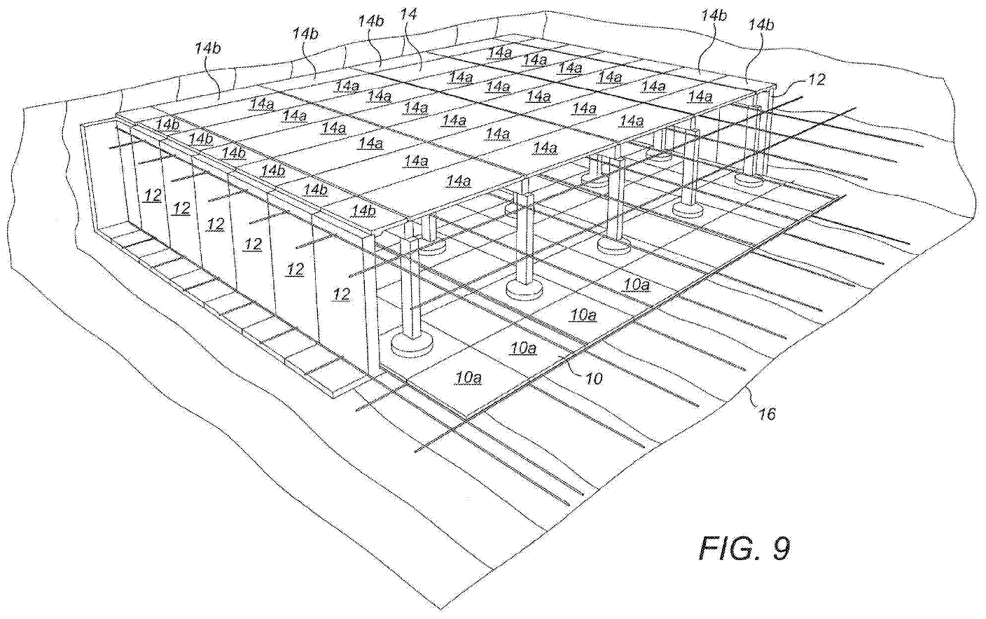

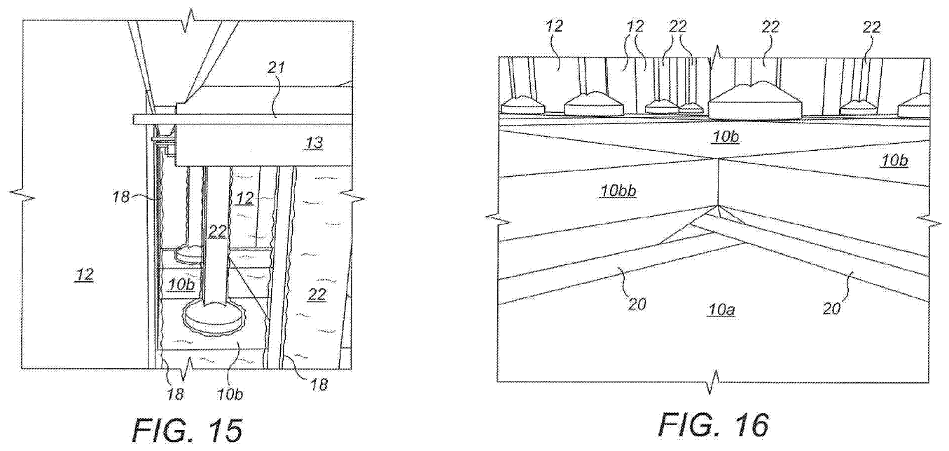

A service reservoir incorporating an electronic leak detection and location (ELDL) system is described herein. As shown partially in FIG. 9, the service reservoir has the following features:
a precast interlocking structure using a double stretcher bond configuration, with precast floor 10 made of sub units 10a (i.e. no in situ cast floor), wall units, or sections, 12 and a roof structure 14 made including lintels 13 and roof units 14a;
ingress leak monitoring of the precast interlocking structure;
egress leak monitoring of the precast interlocking structure;
corrosion monitoring and/or cathodic protection of metallic components within the precast concrete units;
an outer waterproofing liner 16 outside and beneath the precast concrete structure and a protective geotextile inner waterproofing liner 18 (see FIG. 15, not shown in other Figures for clarity, but takes the form of a flexible liner laid out in the tank to retain water, further details below) inside the interlocking structure.

The sub units 10a of the floor are laid in a double layer stretcher bond configuration. The method of constructing the service reservoir will now be described with reference to the Figures.

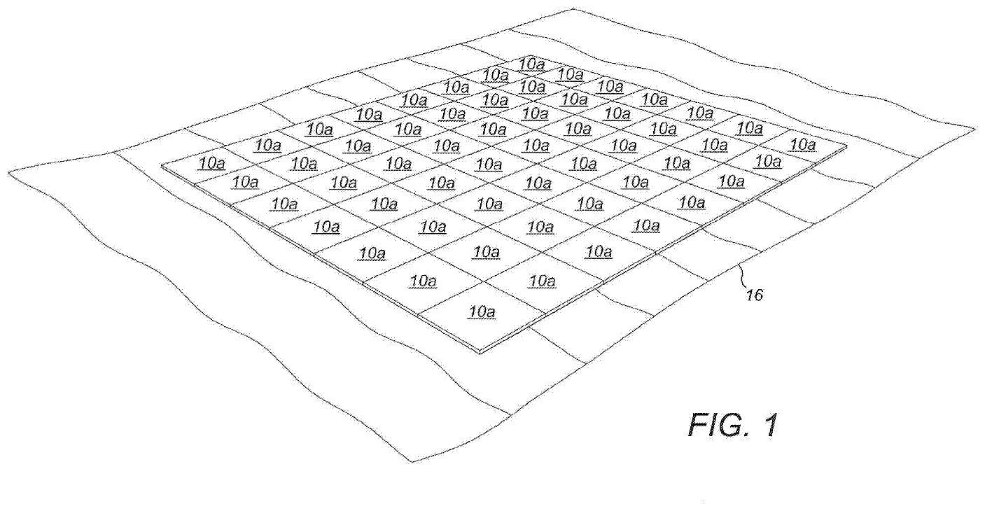

FIG. 1 shows the outer liner 16 placed on a prepared site. A first layer of floor sub-units 10a is then laid in a grid pattern on the outer liner 16.

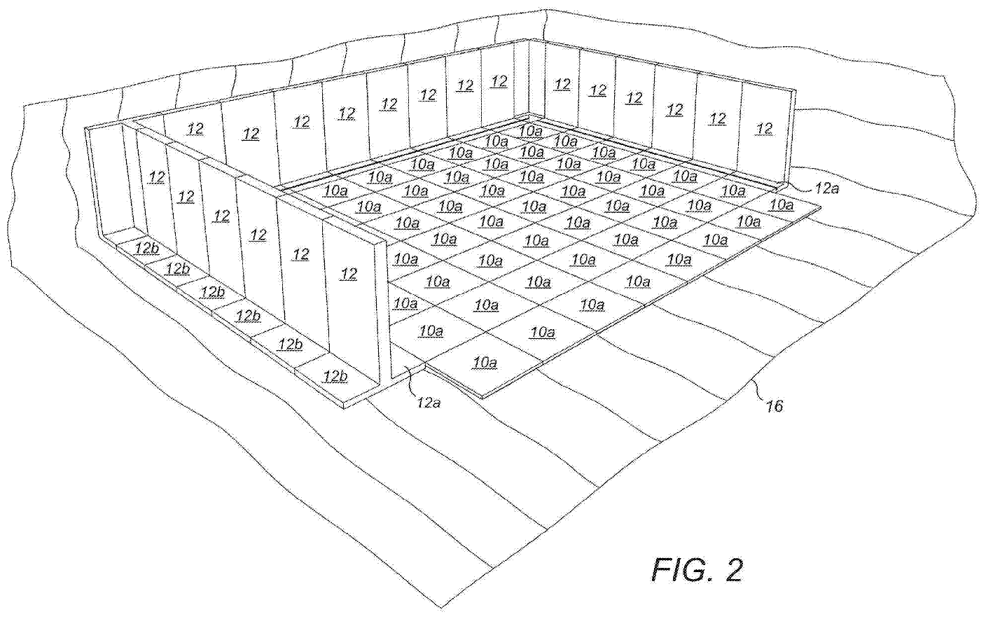

FIG. 2 shows a plurality of wall units 12 placed around the first layer of floor sub-units 10a. The wall units 12 are shown only partially surrounding the first layer of floor sub-units 10a for clarity, but the wall units 12 will form a complete tank shape. The wall units in this example include an inner foot 12a that extends horizontally to support the wall unit 12 in an upright orientation. The wall units also have outer feet 12b, although these are not essential and may be omitted.

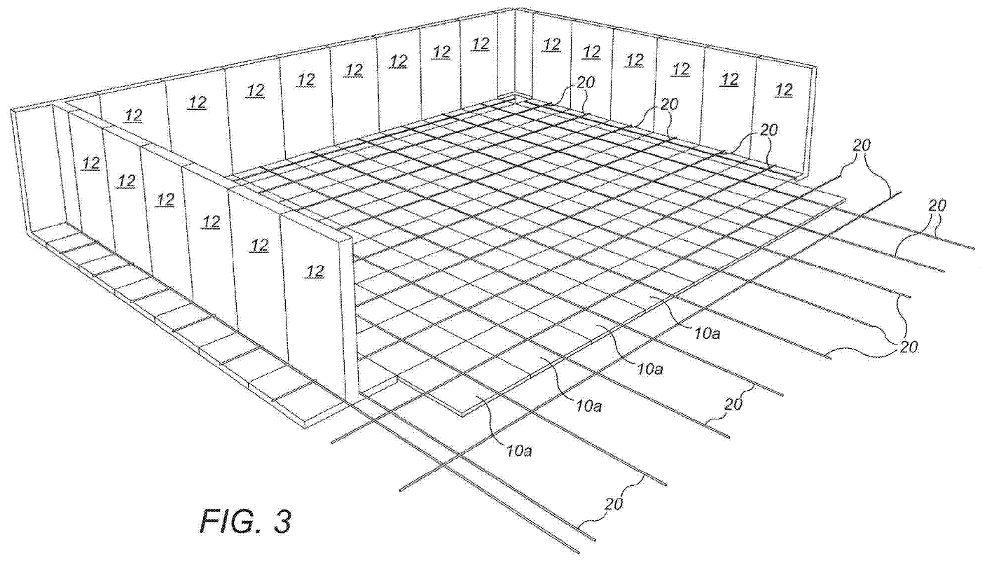

FIG. 3 shows tie bars 20 laid across the top of the first layer of floor sub-units 10a for optional reinforcement.

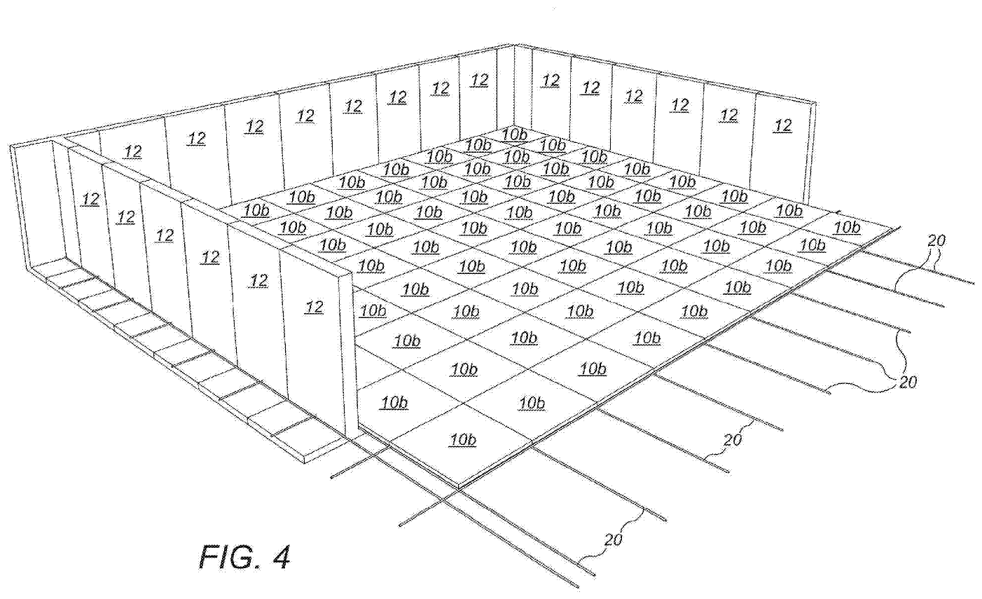

FIG. 4 shows a second layer of floor sub-units 10b having been placed in position over the first layer of sub-units 10a and inner feet 12a of the wall sections 12, thereby locking the wall units 12 in position.

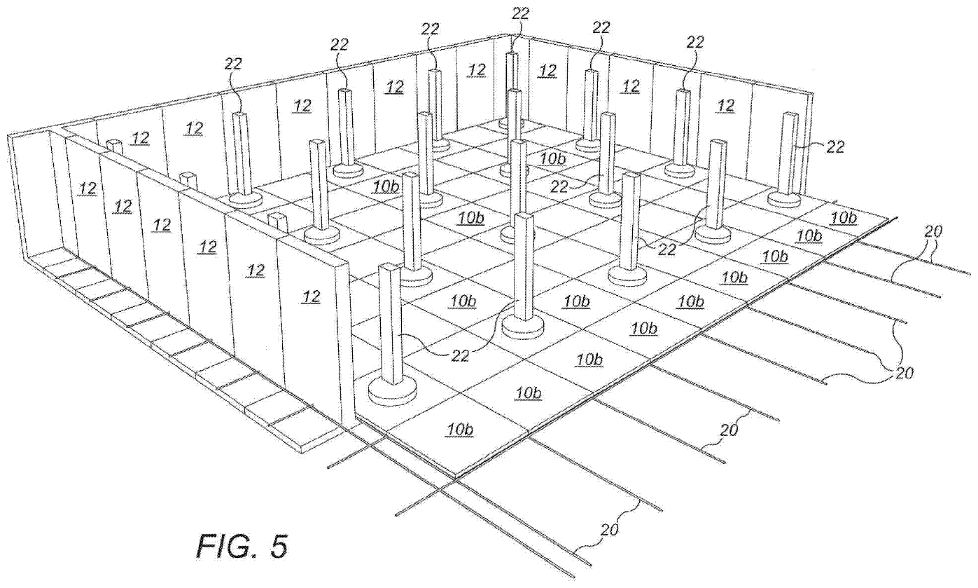

FIG. 5 shows support columns 22 being place in position on top of the second layer of floor sub-units 10b.

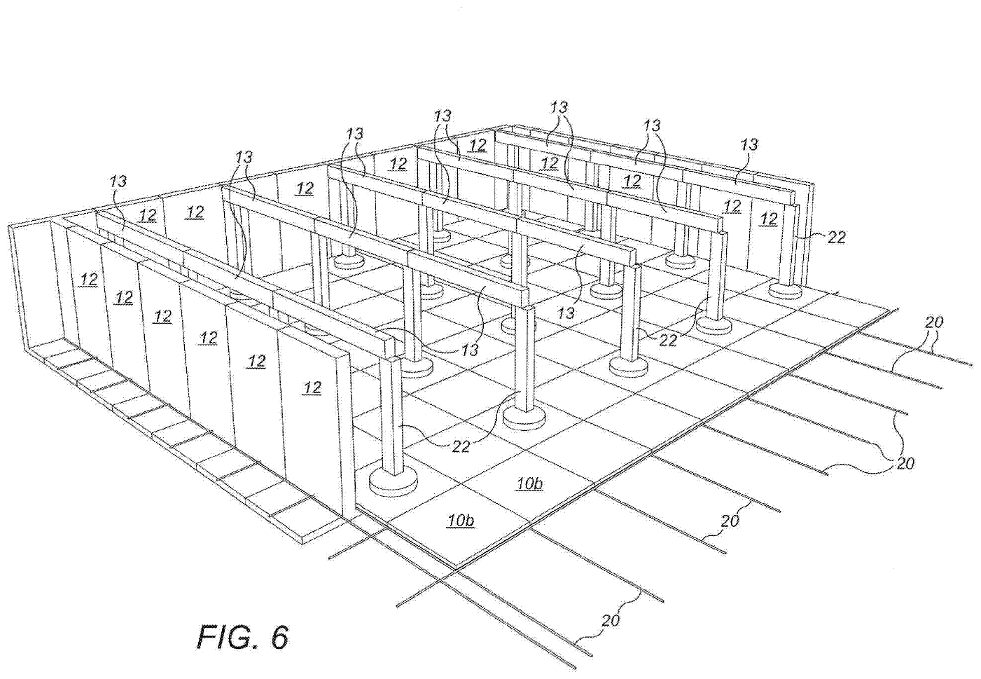

FIG. 6 shows lintels 13 being placed in position between tops of the columns 12.

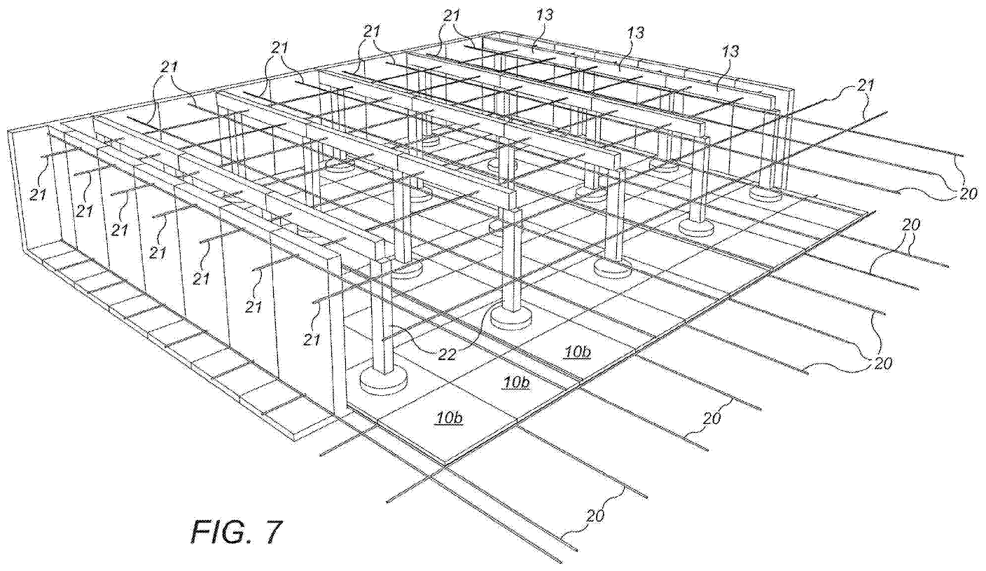

FIG. 7 shows optional tie bars 21 being place in position over the tops of the lintels 13.

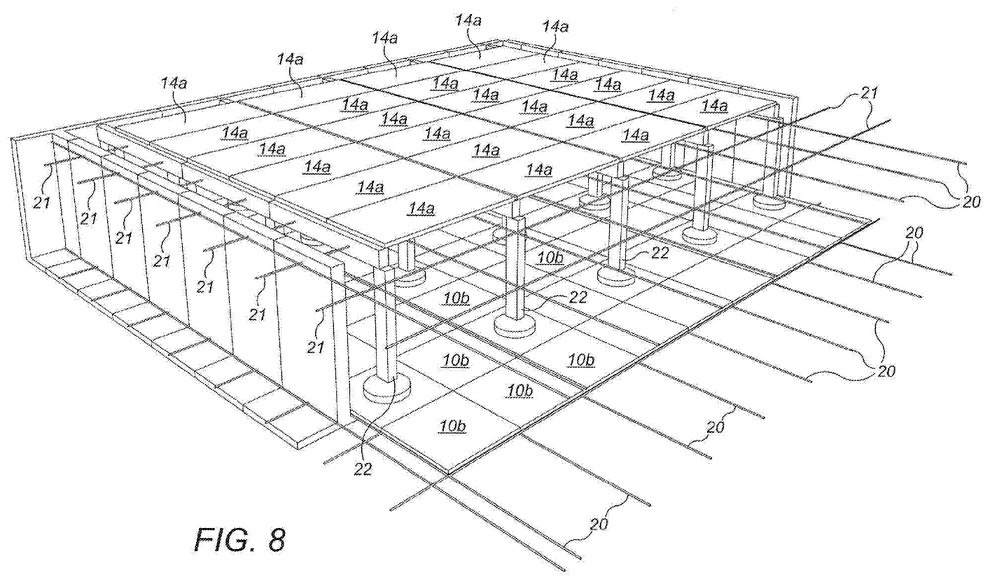

FIG. 8 shows roof units 14a being placed in position on top of the lintels 13.

FIG. 9 shows edge roof units 14b being placed in position.

Various methods of electronic leak detection and location have been disclosed previously. Some of the methods involve the use of a highly resistive plastic geomembrane being installed with electric poles at either side of the membrane. When a fault occurs in the geomembrane an electric connection occurs, which is detected as a current flow.

In one system for electronic leak detection and location a single pole on one side of the geomembrane is used and an operator with another pole being connected to earth outside the geomembrane. The operator carries a pair of sensors and when he passes a hole in the geomembrane a polarity shift is detected, leading to the detection and location of the leak.

In a more sophisticated system, as described in EP0962754, often referred to as a fixed or permanent leak detection system, a network/grid of point sensors is installed beneath the geomembrane to allow for more accurate detection of a leak. For example, sensors may be spaced on a grid of approximately 3 m×3 m, which spacing can lead to a sensitivity of approximately 300 mm. Other grid spacings are possible, for example at intervals of between 3 and 10 metres. In this installation the sensors are located outside the geomembrane, leaks from which are to be detected.

A further improvement of this type of system is to use two layers of geomembrane with the sensors and a conductive geotextile (acting as an electrically conductive signal layer) being located between the two layers of geomembrane (acting as electrical isolation layers) and source electrodes being located outside the two layers of geomembrane in the earth or covering above and below the two geomembranes. The use of two membranes with sensors in between allows an alarm type of detection and location system to be provided, because the sensors are isolated from currents within the material being retained by the geomembrane and also from stray or environmental currents in the earth outside the geomembrane. Thus, when a leak does occur and the moisture leaks into the space between the two geomembranes this allows the electrical signal current to flow with the moisture into the encapsulated conductive textile between the two layers of membrane, the point sensors can detect the increase in current, allowing an alarm condition to be raised if a suitable monitoring system is installed and connected to the point sensors. Such systems exist for both online/permanent monitoring of membrane with suitable monitoring equipment being installed permanently on site and offline systems where only connectors are installed on site requiring power sources and testing equipment to be brought to site in order to test the installed point sensor system manually.

In the embodiment described the ingress and egress leak monitoring is achieved by using the concrete structural members as an electrically isolated conductive signal layer between inner and outer geomembranes made of plastics material.

### Electrical Isolation Layer

An electrical isolation layer is used in ELDL systems that are to be completely buried around the periphery. The purpose is to create an environment within an interstitial space between two geomembranes 16, 18 that is electrically isolated from the outside earth and the internal environment inside the reservoir. An upper 18 of the two geomembranes is often known as the ‘primary waterproofing liner’ and it is the primary waterproofing liner 18 that is normally the ‘service facing’ waterproofing liner. The waterproofing systems that are deployed for the purpose of electrical isolation are electrically non-conductive as is the primary waterproofing liner 18. In this description, the term liner or waterproofing liner will occasionally be used to refer to the geomembrane and vice versa.

In the case of the service reservoir described herein the electrical isolation layer will need to be completely wrapped in the geomembranes 16, 18. The outer geomembrane 16 will be split into three sections:

i. Below the precast floor 10

ii. External to the wall units 12

iii. Across the roof structure 14

The purpose of the electrical isolation layer is to ensure that in the event of damage to either of the geomembranes 16, 18 that an electrical signal current follows any moisture through a hole in the geomembrane 16/18, rather than (in accordance with Ohm's law) where there is a single lining system the signal may simply pass around the edge of the waterproofing liners 16/18 (or, go through a water pipe, or pass through metallic structures/fixings/ladders/railings bolted through the waterproofing liner) if this is the path of least resistance for electricity to travel.

In prior art ELDL systems, where there is a double lining system having inner and outer geomembranes between, there is provided a conductive medium to augment the passage of an electrical signal from a hole in one of the geomembranes to one or more sensors surrounding it. In such prior art systems there would normally be a conductive signal layer (for example non-woven fabric based).

### Primary Waterproofing Liner

The primary waterproofing liner is the ‘service facing’ part of the geomembrane construction and as the name would suggest this waterproofing liner has the primary responsibility for integrity of the waterproofing system. In reality both the inner (primary) 18 and outer 16 waterproofing liners are equally important in terms of electrical isolation enabling integrity monitoring, and in the context of service reservoir described herein one will protect from water/contaminant ingress the other from water egress.

The primary waterproofing liner 18 in respect of the service reservoir would be the face of the waterproofing liner to:

i. Internal tank floor

ii. Internal tank walls

iii. External upper roof waterproofing liner

### Service Reservoir Configuration

In the context of service reservoirs it has been realised that it is possible to eliminate the need for any conductive signal layer within the interstitial space between waterproofing liners 16, 18, by placing the precast concrete units within this interstitial space. This has two advantages:

i. The Electrical Isolation Layer forms the ingress prevention against positive water pressure from outside that tank;

ii. The precast units become the conductive signal layer for the purposes of the ELDL system.

The conductivity of the precast concrete for the floor 10, wall units 12 and roof 14 is controlled to ensure the proposed mix of concrete and steel reinforcement sits within the necessary band of compatibility required by the ELDL system. Also plasticisers are known to significantly decrease the electrical conductivity of concrete and so their use is monitored accordingly.

Therefore, a suitable method would be to test the conductivity of the precast concrete itself to ensure the proposed mix of concrete sits within the necessary band of compatibility required by the ELDL system.

In the event that the concrete cannot be manufactured effectively with sufficient electro-conductive properties to suit an ELDL system, then some material can be incorporated into the casting process, perhaps fixed to the face of the shuttering on either side of the precast unit or added to the concrete mix such as carbon, graphene or steel filings.

The roof can either be constructed using a traditional double lined ELDL system complete with conductive signal layer between within the interstitial space both running over the top face of the roof or the soffit of the roof could be lined with a single liner utilising the structural elements of the roof as a conductive signal layer with a single liner over the top face of the roof.

Alternatively, the roof may not be constructed of concrete and instead could be a floating cover roof incorporating a double-lined ELDL system utilising a tile system approach as described in WO2016/001639, the contents of which are incorporated herein by reference. In drinking water service reservoirs floating covers protect the water from contamination, evaporation, and the loss of water treatment chemicals (such as chlorine). In waste water tanks floating covers prevent odours, collect biogas, and prevent the build-up of algae.

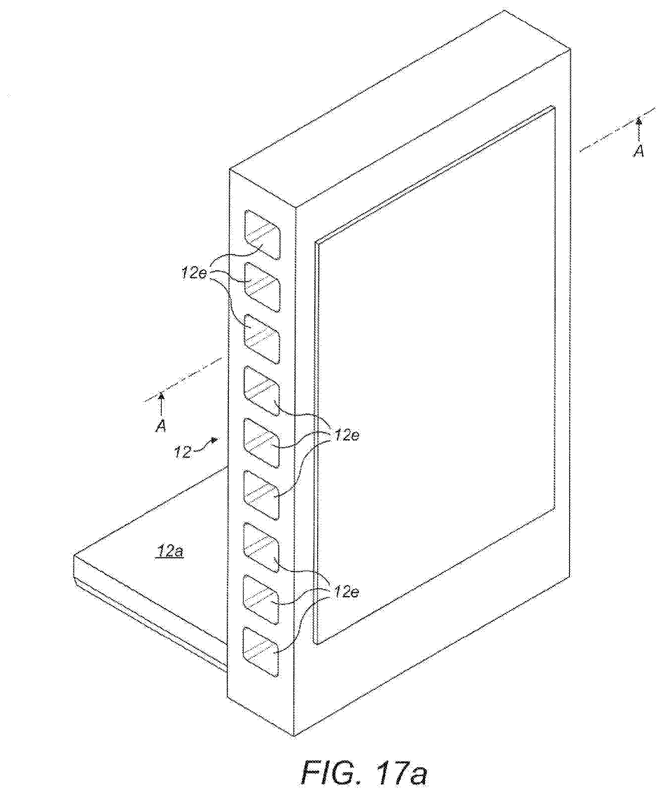

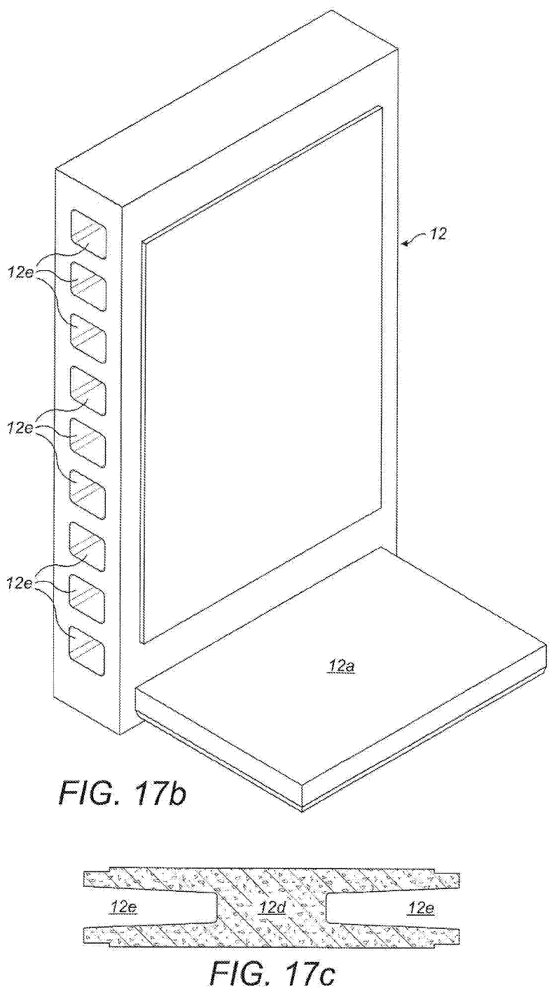

FIGS. 17a-c show an embodiment of a structure of the wall units 12 that provides weight saving (and cost saving). In themselves (even without the weight saving design) the wall units 12 design is unusual, because a gap between the adjacent wall units 12 is not filled. This is because in the service reservoir described herein, the concrete of the floor 10, wall units 12 and roof 14 are not directly providing a waterproofing function as is the manner of conventional concrete tank construction. In the service reservoir described herein the concrete is only required for structural strength/rigidity and to detect leaks through the waterproofing liners 16,18 either side.

Given that the concrete of the floor 10, wall units 12 and roof 14 is not used in any way to waterproof the tank the concrete is free of design constraints that require very high grade concrete with crack width control measures to minimise cracking by introducing very complicated structural design and large quantities of steel reinforcing bars. It is also not necessary for the wall units 12 to be interconnected on site by pouring in-situ concrete and connecting reinforcing cages together with the protruding bars from the edges of each precast units; this mean that gaps can be left between the wall units 12 and those gaps (20-50 mm wide) between the individual wall panels can be used as drainage in case of a leak, whereby any water that might collecting between the liners 16,18 during a leak alert can freely drain out via weep tubes to a waste drain. In addition, as shown in FIGS. 17a-c and described below, it is possible to use formers that are pulled out after casting of the wall units 12 to leave cavities 12e in the edges of the concrete wall units 12, which saves weight, concrete cost, shipping cost and reduces the size of crane required to lift the wall units 12 into position.

The precast concrete wall panels can be produced with ‘pull-out formers’ (not shown), either tapered or split for ease of extraction. The ‘pull-out formers’ are initially fixed to each side of the shuttering (concrete formwork) during production of the wall units 12; this has the effect of excluding concrete from spreading and forms a ‘shear panel’ 12d within the main body of the wall 12 see FIG. 17c). The purpose of the modification to the wall units 12 is to save on weight, whilst maintaining full structural adequacy.

The wall units 12 incorporate a foot section 12a, shown in FIGS. 17a and 17b. This allows the preformed wall units 12 to stand unsupported when delivered to a site. Also, the foot section 12a is laid to abut an edge of adjacent first layer sub-units 10a of the lower layer of the floor. The second, upper layer of sub-units 10b is then laid over the abutting foot section 12a and lower layer sub-units 10a to lock the wall units 12 into position. The weight of the second layer of sub-units 10b in the double layer stretcher bond floor 10 therefore prevents the wall units 12 tipping backwards when the service reservoir is filled.

The structure of this embodiment of wall unit is only possible because of the way the service reservoir is constructed. The ‘pull-out formers’ are the novel part of the design because normally a designer would not be able to create a water retaining structure with the cross-section shown in FIG. 17c. There would be no back to the jointing system necessitated by traditional/conventional design, whether this jointing was hydrophilic sealant or a water-bar for example, but in the embodiment described above uses an ‘open’ joint, so it does not matter.

Therefore, the advantageous transfer of waterproofing functions to the liners 16 and 18 allows for innovative design of the wall units 12 for this service reservoir.

### ELDL Components

With the possible exception of the roofing system (assuming the sufficient electro-conductive properties of the precast concrete units can be achieved, see above) in order to provide a composite construction incorporating ELDL functionality, the sensors, anodes and reference electrodes are deployed within the precast concrete units 10a, 12 themselves. The best method for this is to cast in a tubular hollow perhaps using a prepared timber dowel that when removed will allow the insertion of a flowable grout and sensors/anodes/reference electrodes on site.

The sensors/anodes/reference electrodes of course have a tail of cable attached that needs to exit from the precast units in a common geometrical positions that allows them to be run to a valve house (not shown) of the service reservoir. The best position for the cables to exit is via a booted connection through the roof waterproofing liner inside a HDPE duct that can be bonded to the waterproofing liner itself. The top edge of the precast concrete roof units 14a has a rebate 14c on the inside face below the roof slab but above the waterproofing liner termination where the cables run around the perimeter of the tank (see FIG. 11). It is in the top face of this rebate that there are ‘cast in tubes’ running vertically parallel to the internal face of the precast concrete.

Other alternatives for placement of sensors in the floor 10 &/or the wall 12 would be to leave slots/rebates in the face where sensors can be placed on site then filled with mortar before the waterproofing liner is installed.

For the ELDL of water leaks out of the service reservoir there would need to be a connection to the water inside the tank. One option is to connect onto the metallic valves which themselves have a direct connection to the water inside the HDPE inlet and outlet pipes.

For the detection of a leak into the tank/through the electrical isolation layer then source electrodes must to be placed beneath the lower waterproofing liner and outside the waterproofing liner in contact with the covering material/soil.

The roof 14 could be constructed in a more orthodox fashion with sources above and below the upper and lower waterproofing liners respectively, with the sensors and conductive textile encapsulated between the two. Or alternatively monitoring of the primary liner only could be offered in the event that liner is deployed to the soffit of the roof with source electrodes being placed in the soil/sand/gravel or other covering above the roof.

### Electrical Continuity of Reinforcing Bar

Given that the precast 10a, 12, 14a units effectively have a dual purpose in the service reservoir described, it is advisable that steel reinforcing bars 20 are installed carefully (perhaps pre-welded/tied together into cages) such that within each individual unit 10a, 12, 14a there is electrical continuity of all the steel 20 and additionally a cable, or other connector, should be provided from the cage in each unit 10a, 12, 14a that can then be connected to the adjacent units 10a, 12, 14a. In addition, advantageously the electrical continuity of the steel reinforcing bars inside each unit and to each other, also allows the functionality of corrosion monitoring via installed reference electrodes connected to the necessary control equipment and even cathodic protection of the steel within the precast units via installed anodes connected to the necessary control equipment.

For the purposes of electrical continuity between the precast units and all the steel reinforcement contained therein. The same result can be achieved using protruding stainless steel threaded bar to enable electrical bonding straps to connect the units 10a, 12, 14a together.

An additional option for the construction of the wall units 12 and floor sub-units 10a is to electrically isolate adjacent wall units 12 and/or floor sub-units 10a from each other and allow each entire wall unit 12/floor sub-unit 10a to act as a tile-type sensor, as described in WO2016/001639, the contents of which are incorporated herein by reference.

The leak detection may be implemented by using the reinforcing steel of the wall units 12 and floor sub-units 10a as tile sensors. In this way, the separate wall units 12 and floor sub-units 10a are individually electrically connected to a control unit of the ELDL system, where the control unit analyses signals received from the wall units 12 and floor sub-units 10a to detect leaks from the service reservoir, in particular from the inner lining 18. The reinforcing bars 20 are not used in this configuration.

In this way, breach of either of the inner or outer liners 18,16 will result in triggering of a sensor adjacent to the breach, which identifies a specified location, defined by the area of the wall unit 12, in the service reservoir that has been breached. The area corresponds to the area of the wall unit 12 that has been triggered. Thus, a plurality of defined zones is separately monitored, with each zone being defined by one of the wall units 12 or floor sub-units 10a. The wall units 12 are isolated from each other by the gaps between them, whereas uniquely the floor sub-units 10a can be isolated from each other by using concrete with a higher electrical resistivity achieved by using plasticiser additives, plastic fibres, or resin in the joints between discrete floor sub-units 10a, or by painting the three non-sensing surfaces of the concrete in an electrically non-conductive paint or coating.

### Waterproofing

### Internal Waterproofing of the Service Reservoir

Waterproofing the service reservoir is of course the main concern and there are various systems available that could achieve the required goal:

i. Studded cast-in types of liner cast into the concrete surface during production of the precast units

ii. Spray applied polyurea coatings

iii. Loose laid

There are a number of considerations to take into account in the material selection process:

i. Movement tolerance

ii. Electrical conductivity

iii. Regulation 31 approval (primary) for contact with potable water in the UK or other potable water contact approvals that may be required for such an applications in other geographical locations around the world

iv. Internal finish & slip resistance for personnel entering tank intermittently (primary)

v. Internal durability/resistance to chlorinated water & water jet cleaning (primary)

vi. External durability (electrical isolation layer)

The abovementioned criteria swiftly reduce the attractive options for water proofing on a practical level whilst all would provide the necessary waterproofing and electrical isolation properties required by the concept. There is a danger that anything bonded to the precast units will potentially fail in the event of quite small lateral or vertical movement.

Movement, or the possibility of it, makes both studded cast-in types liner and spray applied systems less attractive, because they are likely to fail. In the interests of completeness however we would also point the other problems with studded cast-in types of liners in relation to the abovementioned criteria which are: lack of Regulation 31 approval; can look scruffy after the casting process; very expensive to purchase; requires a lot of onsite extrusion welding to complete the surfaces between units which can further add to the poor visual appeal of the completed waterproofing system as well the higher cost of extrusion welding over that of fusion/wedge welding.

Polyurea spray applied system suffer none of the issues relating to Reg 31 approval or visual appeal, there is no extrusion welding necessary, but it is likely to crack in the event of movement and it remains a highly expensive option given the thicknesses that will need to be applied to achieve an electrically non-conductive finish which would need to be carefully verified using an ASTM D7953 arc test.

Loose laid waterproofing liner is therefore the most favoured approach and one that could achieve the desired result effectively so long as due consideration is given to the complexity of producing a loose laid waterproofing liner system that provides neat and tidy finish and also the sensitivity to damage by site carelessness of following trades, with particular reference to the waterproofing liner beneath the structure that will be inaccessible once the structure is in place above it.

The most appropriate waterproofing liners for a loose laid waterproofing liner approach are:

i. Polypropylene

ii. Butyl rubber

iii. Polyethylene

iv. PVC

The selection criteria that must be considered here are as follows:

i. Regulation 31 approval (primary) or other geographically required regulatory approval for contact with potable water

ii. Cross compatibility for welding with external/roof waterproofing liner

iii. Electrical conductivity

iv. Weld compatibility with regulation 31 approved pipes or other geographically required regulatory approved pipework for contact with potable water

v. Durability

The first criteria of Regulation 31 approval immediately disadvantages the use of butyl rubber and PVC, in addition these products would struggle with cross compatibility, pipe connections (butyl) and electrical conductivity (butyl) and durability (PVC).

This leaves polyethylene and polypropylene, both materials types are present in materials approved within the Regulation 31 approved list. Polypropylene is an excellent material but one which is really designed around ease of installation making it soft and easily workable, it can also be welded without extrusion reinforcement but this relies on great skill because if polypropylene is overheated in the welding process it release oils that make the weld seem good but allows it to simply fail sometime after the initial installation. Polypropylene's Achilles heel is the very flexibility which is it most beneficial property, this makes it extremely easy to damage both during and after the installation and with particular reference to high pressure cleaning. Another consideration with polypropylene is that it is not cross compatible with any form of pipework currently on the market.

This leaves us with polyethylene and in turn the Regulation 31 Approval means that we have only HDPE to work with. HDPE is a stiff and very durable material that will last an extremely long time, the problems with it relate to its installation due to its stiffness but those who are used to working with it have no reservation about lining a tank with it.

The question of neatness is still an issue. In order to create a neat installation it will be necessary to try to design and install the tank in a manner that suits the lining of it, rather than the normal position which is that a leaking tank not designed to be lined is fitted with a liner ‘bag’. One consideration under the Construction Design and Management Regulations in the UK with regard to the operation and maintenance of the tank is the slipperiness of wet HDPE waterproofing liner where the designers would need to consider the risk to the end users or maintenance crews. Slipperiness of the floor liner could be a major issue during the cleaning and inspection of tanks in service which we would overcome by the use of a structured/textured finish for the floor waterproofing liner.

### Optimum Tank Geometry for Internal Lining

The optimum geometry for the tank on plan would be lozenge shaped or a square/rectangular shape with curved internal corners.

The inner waterproofing liner 18 covers an upper layer of floor units 10b, the interior of the wall units 12 and the exterior of internal columns 22.

It is also desirable to minimise or eliminate any angular detailing such as column thrust blocks, ideally the columns 22 will be circular and dropped into ‘sockets’ in the floor 10 in order to keep the floor waterproofing liner as flat as possible with only the scour/sump and the wall 12 to floor 10 joint necessitating changes in the direction of the waterproofing liner.

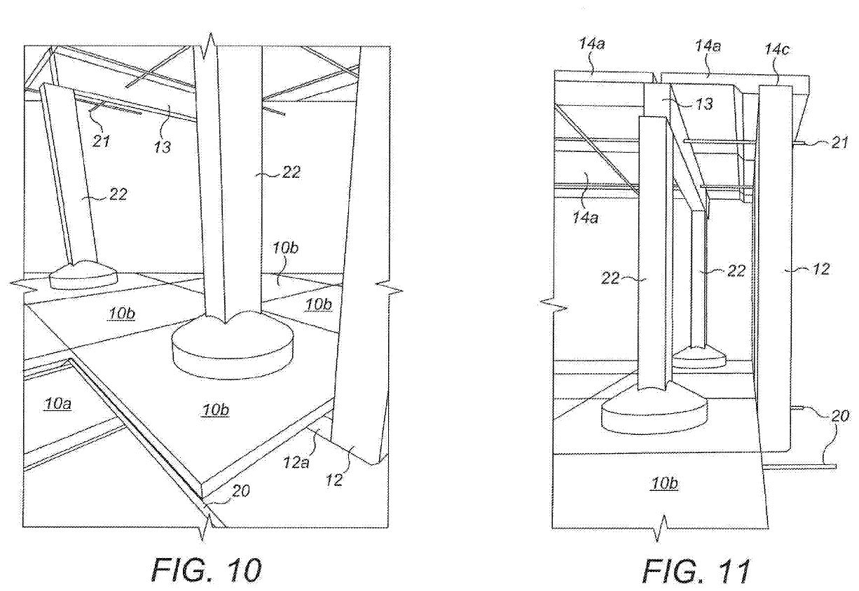

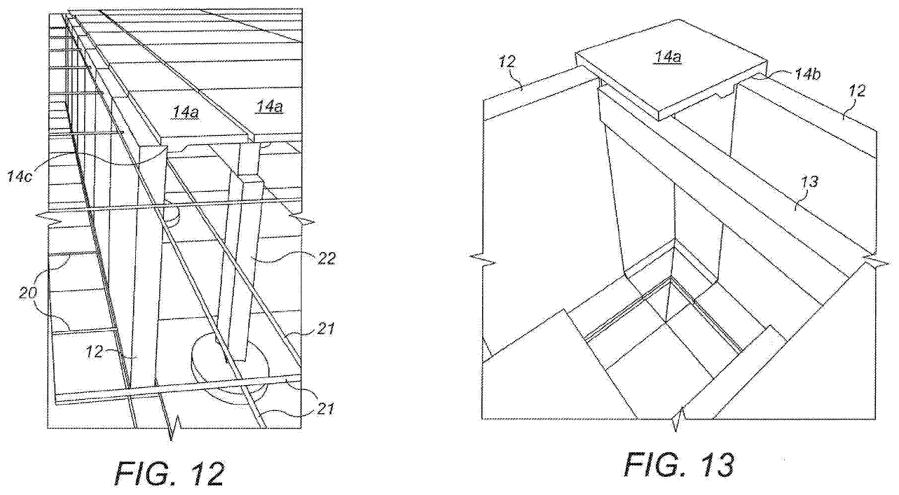

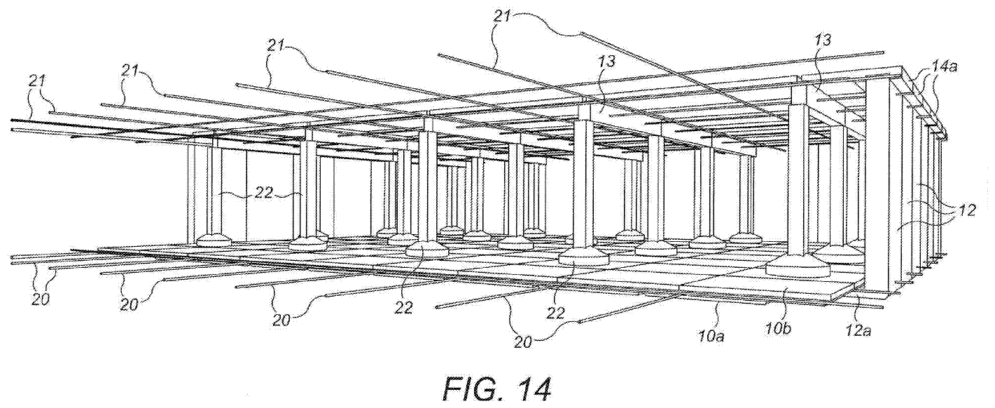

The roof 14 includes lintels 13 that are laid across the tops of the columns 22, as shown in FIG. 6. Steel reinforcing bars 21 are then located (see FIG. 7) in a grid pattern through openings in the lintels 13 and at upper parts of the wall units 12 (or possibly in lintels 13 laid on top of the wall units 12). After that the roof units 14a are placed on the lintels (see FIGS. 8 and 9). Detailed views are shown in FIGS. 10 to 13, showing the rebate 14c in the roof units 14a. FIG. 14 shows a view without the inner liner 18 from eye level to show the internal detail. FIG. 16 shows the inner liner 18 only schematically, particularly showing the joins, given the transparent nature of the liner 18. FIG. 16 shows chamfered lower edges of the upper floor units 10b to show how the reinforcing bars 20 are received.

### Columns

One option for the lining of the columns 22 is to use HDPE pipes as permanent external sleeves for precast concrete columns 22, although if we use these pipes as ‘formwork’ in fact the HDPE pipe will need to be retained by a rigid metal shutter whilst the concrete cures inside to ensure that the HDPE pipe does not deform with the warmth of the concrete's chemical curing process.

It is envisaged that if this technique could be developed (using Regulation 31 Approved pipe) then it would vastly simplify both the lining and the connection between floor waterproofing liner 16 and column 22, where the waterproofing liner 16 could be welded directly to the foot of the column sleeve.

Another alternative could be to use precast concrete columns 22 to suit the internal diameter of available HDPE pipe and drop the pipes over the concrete columns 22 to form a cover, although this option does then require a further operation on site. Although in the alternative this might improve the ability to place sensors within the columns 22 or get floor sensor cables out of the tank waterproofing liner 18 more easily through cast in channels in the face of the columns 22.

Again electrical continuity of the columns 22 with the reinforcing bars 20 in the remaining units 10a, 12, 14a would need to be considered and connections made to the floor and roof to make the entire structure electrically continuous.

Along the centreline of a row of columns 22 we could envisage using an HDPE casting in termination profile being deployed, cast into the floor units. This would allow the neat termination of the floor waterproofing liner with an extrusion weld running along the aforementioned column centreline. This would avoid the necessity to have holes in the waterproofing liner before and after each column in order to remove a fusion welding machine after forming the wedge weld between liners at junctions between horizontal and vertical structural elements, which would then have to be patched with unsightly round sections of geomembrane with extrusion weld around.

It is important that during the casting process the cast in HDPE profile is installed carefully, straight and allowing enough overhang within a shutter (perhaps bulked with polystyrene either side to allow slight protrusion of the plastic profile, thereby allowing the casting profile itself to be butt welded to the adjacent profile in the next/adjacent precast unit.

### Wall Floor Junction

Adapting further sections of Regulation 31 Approved HDPE pipework for use in the service reservoir by cutting some pipes lengthways into quarter segments and using this as a ‘skirting’ detail around the perimeters as an alternative to a filleted concrete wall/floor detail. The idea would be to form skirting from the quarter segments and then weld them together in the same way as fusion butt welding full pipes (except by hand). This would provide an excellent termination detail for both the wall waterproofing liner and the floor waterproofing liner, where geomembrane can be extrusion welded to the ‘cove skirting’.

The reverse approach could be used around the edge of the scour, which is a drain in the floor where the outer curve of the pipe could be used, to change lining direction and similarly at the foot of the scour the same detail as the floor wall joint could be created where the inner curve of the pipe could be used as a ‘cove skirting’ to change direction of the liner as described above.

Even where the corners of the tank are rounded internally it will be possible to create this ‘cove skirting’ detail by cutting out lateral segments of the quarter section and welding them back together to form the curved skirting detail, or simply using geometry cut out of standard pipe bend and t-junction sections.

Finally all the cove skirting can be fixed with bolts countersunk sealed with hot extrudate from an extrusion welding machine.

### Wall Fixing Details

At the top of the wall units there may be cast in HDPE profiles where the waterproofing liner will be extrusion welded in order to secure the leading edge of the waterproofing liner. Alternatively the outer liner can pass through the wall roof joint allowing the inner liner to be welded to it by extrusion or fusion welding techniques.

It should be an aim to minimise the vertical fusion weld between geomembrane sheets mainly for aesthetic purposes. Rolls of geomembrane are approximately 5.5 m wide or 7.2 m wide this would represent the lined depth of the service reservoir offering and we would intend to try and deploy the waterproofing liner vertically from an articulated dispenser perhaps from a crane.

We envisage temporarily bolting a number of modified geomembrane installer's mole cramps to some cast in sockets aligned vertically on one precast unit that would represent the starting point to temporarily pin the end of the geomembrane to the wall allowing the crane to pull out the membrane along the wall.

As the process proceeds at regular intervals (to be determined e.g. 1.00 m centres, or less both vertically and horizontally) the geomembrane installer will secure the waterproofing liner to the walls using ‘tabs’ of the waterproofing liner material (e.g. 150 mm×150 mm) welded vertically to the rear of the geomembrane one side only. Then the flap that has been created can be fastened/bolted/shotfired to the wall before the other vertical side of the flap is also welded to the back of the geomembrane (if working space permits).

As work on the tabs proceeds in the mid-sheet area of the waterproofing liner it can also be extrusion welded at the top to the cast in profile and at the bottom to the cove skirting detail.

Alternatives to this process may exist but do need further investigation and testing:

i. Clip together discs for ‘temporarily’ clipping membrane to soffits of tunnels. Increasing the recommended number of these discs per m2 and the fact they are installed on a wall not a soffit may enable their permanent installation on site.

ii. Velcro discs for ‘temporary’ securing membrane in tunnels. Again increasing the recommended number may allow these to be relied upon permanently with sufficient testing.

iii. Casting in 150×150 tabs of studded cast-in types of liner then ‘gluing’ the back of the wall waterproofing liner to it as it deploys may be an option but again this would require some testing to look at the sort of strength that could be achieved with this method.

iv. Casting in 150 mm long ‘tabs’ of HDPE casting profile may also be an option fixed as described in (3) above, again subject to laboratory bond testing.

v. Holes cast though the wall units at regular centres would allow coach bolt fixed through a ‘tab’ of waterproofing liner and extrusion welded to the rear face of the waterproofing liner would effectively allow the waterproofing liner to be secured from the outside of the tank.

### External Waterproofing of Service Reservoir

We envisage laying source electrodes, 1000 g conductive geotextile and waterproofing liner directly to the excavated site before the delivery of the precast units and MIT will be carried out. The waterproofing liner would then be protected by a further layer of 1000 g conductive geotextile before either the precast units are placed directly on it, or concrete blinding is poured on top of it. The waterproofing liner can be tested for integrity after the blinding is poured and in the unlikely event of damage any isolated repairs can still be carried out by breaking out areas of damage repairing and recasting before placing of the precast units.

Once the internal works are complete with all inlet and outlet pipes installed and the precast roof in place, the lower waterproofing liner can be laid across the roof on top of a layer of source electrodes and conductive textile. The lower roof waterproofing liner is then welded to form a continuous sheet before being ballasted and having further sheets of waterproofing liner extension fitted to its perimeter that can the pass down the sides of the tank and be connected to the waterproofing liner beneath the precast units/concrete blinding layer.

Sensors and conductive textile are fitted to the roof area then the primary roof waterproofing liner is fitted over the top secured at the perimeter to the lower waterproofing liner around the perimeter of the tank below the wall joint.

Source electrodes can be fixed to the side walls of the service reservoir before the drainage geocomposite is placed over the waterproofing liner on the roof and all the way down the sides of the reservoir. Then final source electrodes for the roof can then be placed on top of the drainage geocomposite.

The continuous or remote leak monitoring electronics should already be wired commissioned and running before commencement of the backfilling to the sides or roof. This will allow the testing process to occur as the backfilling progresses with alarms occurring in the event of any damage as the work proceeds.

### Advantages

Structural Design Requirement

By encasing the structure in smart membranes, the design eliminates normal concrete (reservoir) code requirements for crack-width control, durability and hygiene. The structure may allowably flex more, have less concrete cover and less prefect surface finishes than would pertain to normal structures exposed to earth and stored water.

Precast Slab on Grade

Conventionally, precast concrete slabs are not used in ground slab construction due to the difficulty in preparing a bed of sufficient flatness to eliminate excessive stress as a result of high points and low points in the sub-grade. These would conventionally result a rocking action and indeterminate flexural forces with excessive strains which may compromise durability, hygiene and serviceability.

Although a self-levelling screed is used to top the sub-base for the protection of the geomembrane, moderate differential settlements do not compromise this structure.

The precast concrete slab design consists of two layers of concrete tile strategically overlapped at the joints. This creates a stretcher bond effect to enhance the distribution of load and is so located that the internal columns land centrally on the upper units and never on their joints. This design feature protects the membrane beneath the column and ensures the proper distribution of load to the substrate.

Essentially the overlapping tile design eliminates differential shear forces either side of the lower joint lines, which would otherwise result in differential settlement capable of damaging the outer membrane.

Placement of Structural Ties in the Slab on Grade.

By adapting the edges of the precast floor tiles a void is created for the integration of the structural tie grid required to resist water pressure forces at the base of the perimeter wall units. This avoids any compromise to the membrane by their presence and places the tie forces centrally in the floor plate thus avoiding the potential development of eccentric moment.

Waterproofing Component

Although a concrete reservoir, the concrete components have no function in the waterproofing integrity of the system. This is a unique feature eliminating dependence on sealant-bond and concrete properties.

Demountable

Components of an installation may be demounted for use in part, in whole, or as part of larger installations elsewhere.

Adaptable

The system can be easily enlarged (or reduced) to accommodate future demand requirements.

Constructability

The innovation brings less reliance on fair weather during construction.

Thermal Design

The innovation eliminates the requirement for thermal steel design and thermal steel provision as required by the design of large conventional in-situ floor slabs, walls and suspended structures.

Construction Impact

Significantly fewer personnel are required for less time than with normal construction. Significantly fewer traffic movements are required with less dust, noise, disturbance and impact on neighbours.

Transport is optimised by designing elements to realise the load-carrying capabilities of the delivery vehicles.

Export Capabilities

Complete reservoir assemblies are highly transport efficient—for export, disaster relief and overseas infrastructural development projects.

Membrane Continuity

The design includes a cantilever perimeter roof beam device which facilitates proper detailing of the membrane.

Retaining Structure with Inclined Wall

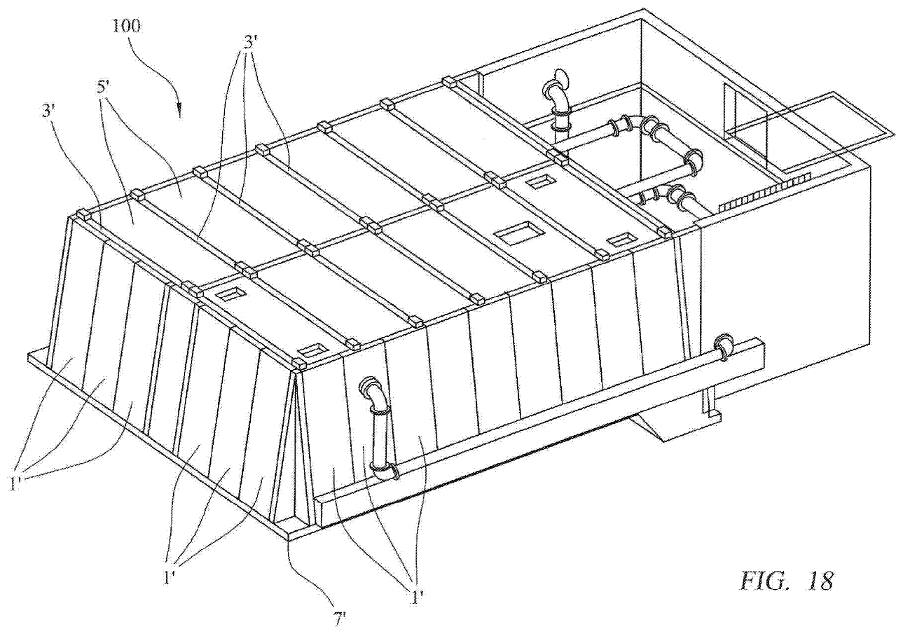

A further exemplary retaining structure of the present invention will now be described with reference to FIGS. 18-23.

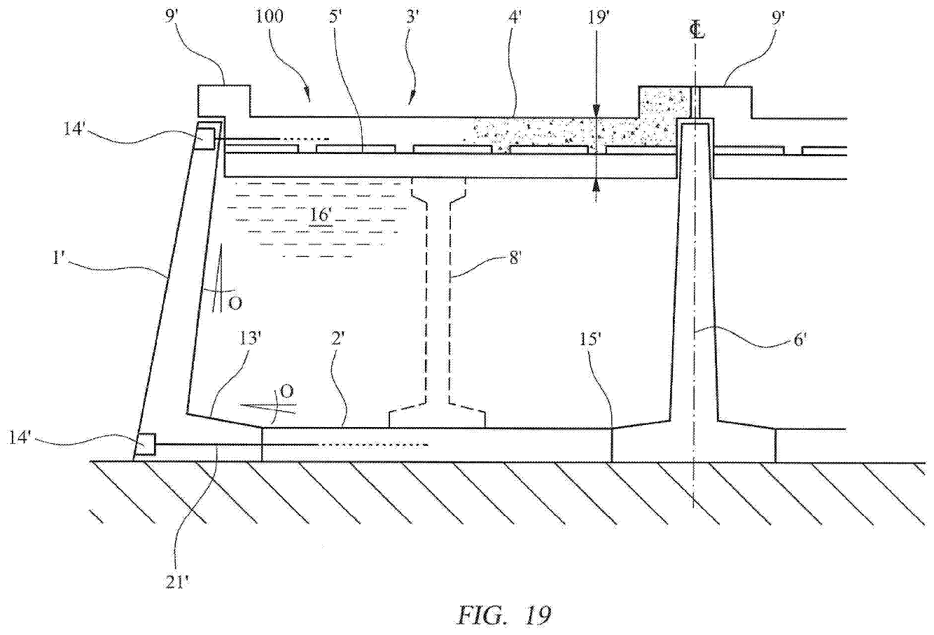

FIGS. 18 and 19 respectively show perspective and cross-sectional views of a retaining structure 100. The retaining structure 100 takes the form of a tank, though it will be understood that it may take the form of another retaining structure as described herein.

The structure 100 incorporates a post-tensioned concrete floor 2′, sidewalls formed of inclined precast concrete wall unit 1′, a cassette/suspension beam primary roof support 3′, preformed roof units 5′ and an in-situ roof screed 4′ incorporating tendons 21′ for the restraint of the top of the perimeter wall units.

Corner wall units 7′, which are best seen in FIG. 22 and that are described in more detail below, form the junction between adjacent side walls of the fluid retaining structure 100, and thus close the structure 100 at the corners. Furthermore, in some examples, internal dividing wall units 6′ subdivide the structure if preferred. In exemplary structures having larger roof areas, internal columns 8′ may be provided.

### Wall Unit

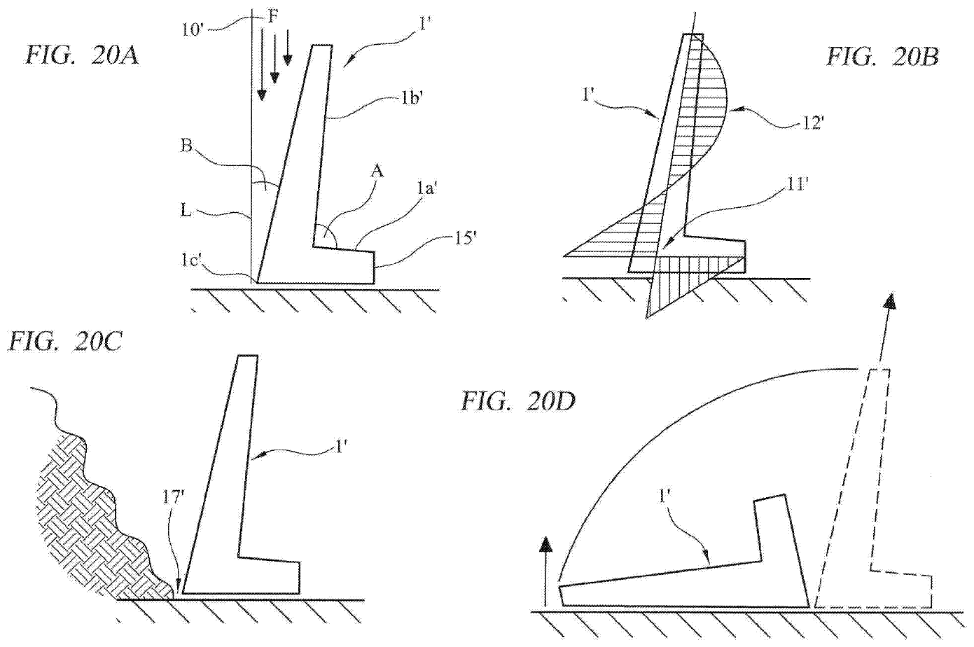

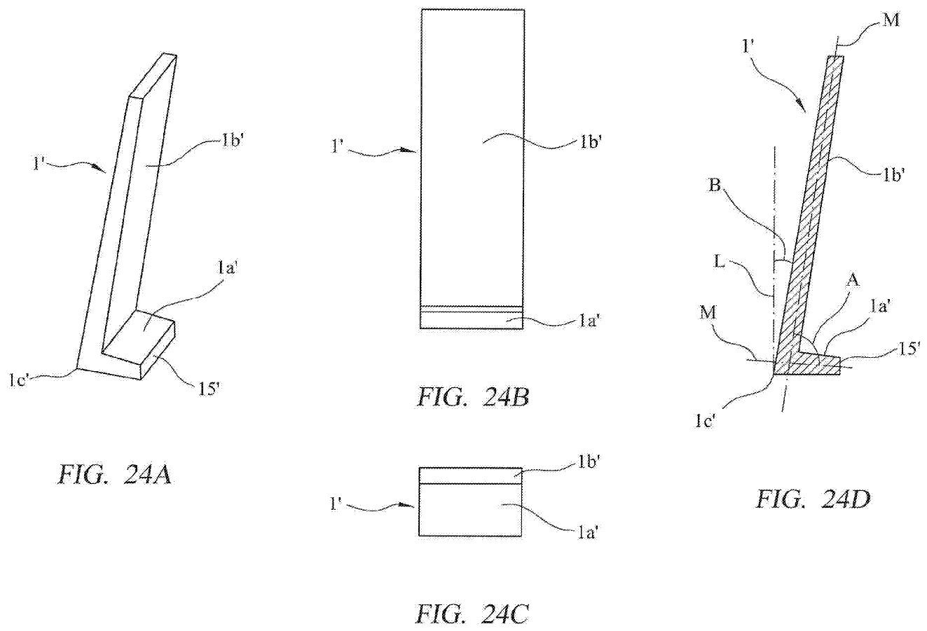

The wall unit 1′, which can be best seen in FIGS. 19, 20A-D and 24A-D, comprises a foot portion 1a′, the underside of which is arranged to contact the ground, and a wall portion 1b′. The wall unit 1′ is configured such that the wall portion 1b′ is inclined over the foot portion 1a′. Particularly, the wall portion 1b′ extends upwards at an angle from the foot portion, so that an acute angle A is formed therebetween, on the side of the wall unit 1′ that forms the interior of the retaining structure 100. As can be best seen in FIG. 24D, the acute angle A may be measured between major axes M extending through each of the wall portion 1b′ and foot portion 1a′, so as to not account for any variation in thickness of the respective portions. The wall portion 1b′ is thus inclined from a vertical plane L at an acute angle B. Accordingly, this configuration ensures that the unit 1′ is stable during construction and assembly, in that its centre of gravity is substantially disposed within the centre of the foot portion 1a′. This eliminates the requirement to manufacture specific stability devices, or the need to use temporary propping devices, in order to retain the wall unit 1′ in position, and so prevent it falling over during the construction phase.

In one example, the ratio between the length of the wall portion 1b′ and the length of the foot portion 1a′ is in a range of approximately 6:1-3:1. In one example, the acute angle B is in a range of approximate 5°-35°. In one example, the acute angle A is in a range of approximately 55°-85°. It will be understood that the lengths of the portions and the angles may be varied, so long as the centre of gravity is substantially disposed within the centre of the foot portion 1a′.

In one example, the wall portion 1b′ extends upwards from the outermost end of the foot portion 1c′, so that the foot portion 1a′ does not extend outwards beyond the exterior face of the wall portion 1b′. In other words, no stabilising footing is present at position 17′, as is best seen in FIG. 20C.

In one example, the wall portion 1b′ tapers in thickness as it extends away from the foot portion 1a′. Accordingly, the wall portion 1b′ is thicker at its lower end than its upper end. Additionally or alternatively, the foot portion 1a′ tapers in thickness as it extends away from the wall portion 1b′. Particularly, the upper surface 13′ of the foot portion 1a′ may slope downwards away from the internal corner towards the toe portion 15′ formed at the innermost end of the foot. Accordingly, relatively more mass is present at the junction between the foot portion 1a′ and wall portion 1b′. The sloped surface 13′ also aids drainage of the perimeter zone of the structure 100.

The leading edge of the toe portion 15′ of the foot portion 1a′ interfaces with the post-tensioned floor 2′ and acts as a permanent form and guide device to determine the top level of the post-tensioned floor 2′.

In examples where an external membrane is employed on the exterior of the wall unit 1′, the application of the membrane around the footing is simplified, as it forms an acute dressing around the external corner between the wall portion 1b′ and floor portion 1a′, rather than having to negotiate the complexity of dressing around an isolated stability footing.

As can be seen in FIG. 20A, when the retaining structure 100′ is backfilled, the vertical component 10′ of the force exerted by the backfill mass contributes to floatation resistance of the structure 100 as a whole. As is illustrated in FIG. 20(B), the unit 1′ mobilises double bending, thereby improving the structural efficiency of the unit in resisting earth, gravity and hydrostatic loading. Bending moments are developed substantially at the junction between the wall portion 1b′ and the foot portion 1a′, and approximately at the mid-height of the wall portion 1b′.

In addition, in examples where the retaining structure 100 is used to store liquid, the narrowing of the upper region 16′ of the tank that occurs due to the angled wall configuration reduces the volume of freeboard. The inclination of the wall portion 1b′ improves the efficiency of the roof 2′ by reducing the overall span. Accordingly, the overall area of roof to be constructed is reduced, with associated cost and time savings. In further examples, the roof may be a preformed arched roof, further improving structural efficiency and thus avoiding the use of columns in longer span applications.

As can be seen in FIG. 20(D), uprighting operations of the unit 1′ on delivery to site are simplified. The unit 1′ can be easily transported in a substantially horizontal configuration. Furthermore, the unit 1′ is not inclined to over-topple at near the vertical position. This eliminates the requirement for an uprighting trestle on delivery.

Returning to FIG. 19, in one example the wall unit 1′ comprises stressing heads 14′, respectively formed at upper and lower portions thereof. The lower stressing heads 14′ are arranged to tension the floor 2′ as will be discussed below, and the upper stressing heads 14′ are arranged to anchor the roof to the wall unit 1′. In one example, the stressing units 14′ are integrated in the wall unit at manufacture, thereby improving efficiency during assembly on site.

Whilst the wall unit 1′ has been described in relation to a tank, it will be appreciated that the wall unit 1′ could be employed in other structures. For example, a non-exhaustive list of potential applications includes:

Service Reservoirs and Other Liquid Storage Applications

Bridge Abutments

Aggregate Stores

Retaining Walls

Blast walls

Embankments

Superstructures

### Corner Unit

Referring now to FIG. 22, the retaining structure 100 comprises a corner unit 7′, which forms the junction between adjacent sidewalls of the structure. In one example, the corner wall unit 7′ is formed of precast concrete.

The corner unit has two walls 7a′, 7b′, which are arranged orthogonally to each other, so as to interface with respective sidewalls. It will be understood that the angle between the walls may be varied in embodiments where the sidewalls are not arranged orthogonally. Each wall 7a′, 7b′ tapers from base to tip, so as to match the incline of the wall unit 1′. Accordingly, the geometry of the corner unit 7′ matches with the most proximate wall units 1′, thereby closing the gap therebetween.

The matching sloped interface facilitates the dressing of a membrane across the interface between the corner unit and wall unit. It closes the opening resultant from the convergence to the typical wall units at corner locations. In addition, the taper from base to tip ensures that the corner unit 7′ can stand freely without support, thereby easing construction.

In addition, the corner unit 7′ may comprise anchorage points 7c′ for tendons 21′ in the floor 2′ and roof proximate to the perimeter of the structure 100. Such tendons 21′ tension the sidewalls with respect to the corner units 7′, thereby holding the parts together.

### Floor

In this example, post-tensioning tendons 21′ extend from the lower stressing heads 14′ of a wall unit 1′ through the precast units of the floor 2′, which are similar to the units 10a described hereinabove, and to a corresponding anchorage point on a corresponding wall unit 1′ of the opposing sidewall. Alternatively, the tendon 21′ may extend to a dividing wall 6′,

Once tensioned in situ, the tendons 21′ serve a dual purpose of reinforcing the floor 2′ and restraining the wall units 1′ against sliding under internal hydrostatic pressure. The benefits of using a post-tensioned floor in conjunction with the precast concrete perimeter wall units include fewer joints, less reinforcement, a thinner floor section, and faster construction.

### Roof

The roof of the structure 100 comprises a plurality of suspension beam roof supports 3′ and a plurality of preformed roof units 5′.

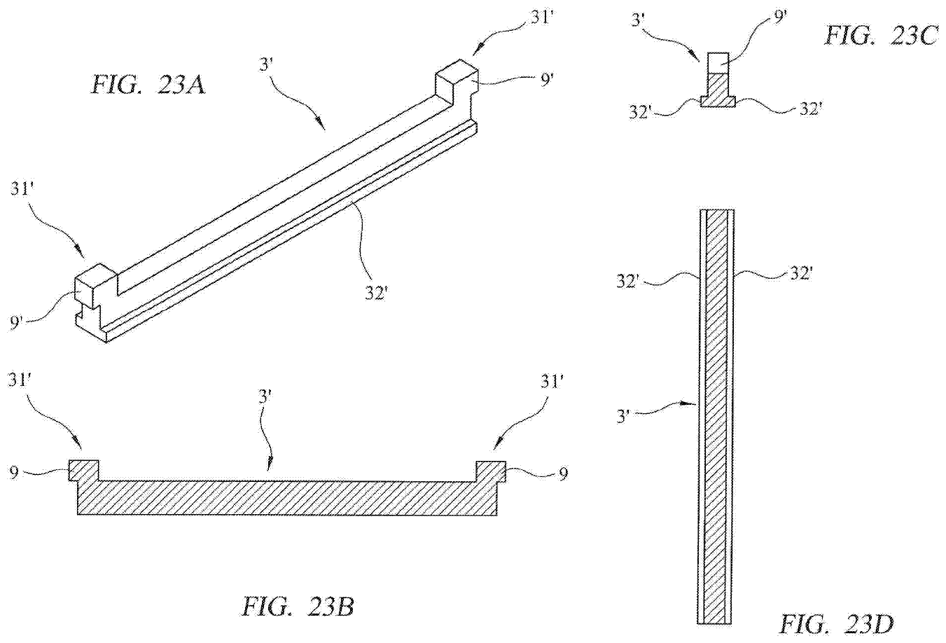

A suspension beam roof support 3′ is shown in detail in FIG. 23. One or both ends 31′ of the beam 3′ is arranged to engage a corresponding wall unit 1′ or dividing wall 6′. A corbel 9′ constructed at the top of the beam 3′ at one or both ends for engagement with the wall unit 1′ or dividing wall 6′, and enables the top surface of the beam 3′ to rest level with the top of the supporting wall 1′,6′ at one or both ends.

Furthermore, the beam 3′ comprises a shelf 32′ extending longitudinally along one or both side faces of the beam 3′. The shelf 32′ is arranged to support conventional or special precast concrete (or other structural) roof units 5′, which may take the form of plates, which are disposed between adjacent pairs of beams 3′. The roof units 5′ may or may not be dressed with a screed 4′, as will be described below. Accordingly, the beams 3′ effectively define a cassette into which the roof units 5′ are inserted.

The advantage of this approach is that the suspension cassette beams 3′ can be located on plan wherever necessary to accommodate openings, vary spans, support internal elements or other design elements. A further advantage is that, in the temporary and service condition, spans can be increased by mobilising the full depth of the combined roof and beam section (19′, see FIG. 19). In addition, in membrane applications where isolation between the wall and roof is required, this suspension arrangement facilitates the isolation without special treatment of the membrane. Still further, the suspension arrangement may function as a plinth supporting items mounted on the roof.

### Roof Screed

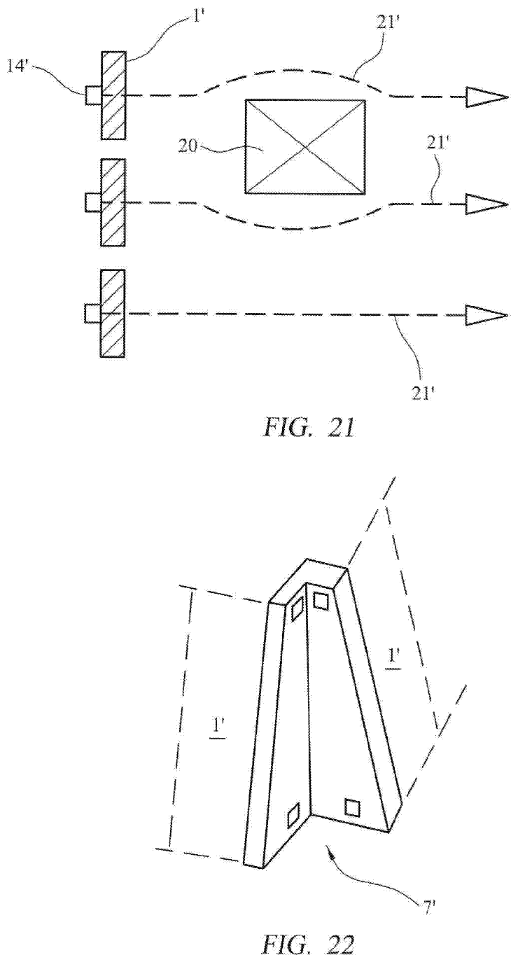

In one example, a roof screed 4′ is provided for the purpose of levelling the finished roof surface, and providing a uniform perimeter bearing for the top of the perimeter wall units 1′ subject to external lateral pressure. As is best seen in FIG. 21, the roof screed 4′ incorporates post-tensioning strands or tendons 21′. In one example, the tendons 21′ do not serve to post-tension the roof, but instead act to restrain the wall units 1′ against lateral displacement under internal pressure.

In examples where the roof units 5′ comprise openings, the screed 4′ secures the tendons in a path curving around larger openings, such as the opening 20′. Accordingly, continuity of the tendons 21′ is maintained around larger openings in the roof units 5′ without interfering with the opening 20′. Furthermore, the incorporation of the tendons 21′ in the screed 4′ eliminates the risk of corrosion of the tendon if located below the roof units 5′.

### Overview of Construction

In use, the retaining structure 100 is formed by assembling four sidewalls from plural wall units 1′, with corner units 7′ disposed between adjacent sidewalls. The floor 2′ is then laid. Alternatively, it may be laid before the wall units are assembled. Tendons are passed through the lower parts of corner units 7′ and wall units 1′ and the floor, and are tightened by the stressing heads to bring the structure into tension.

The roof is then installed by disposing the beams 3′ between the wall units 1′ and/or dividing walls 6′, and then disposing roof units 5′ therebetween. Optionally, the screed 4′ is laid over the roof units 5′ and beams 3′. Tendons are passed through the upper parts of corner units 7′, wall units 1′ and through the roof (e.g. through the screed 4′).

It will be understood that the features of the embodiment described with reference to FIGS. 18-23 may be combined with the features of the embodiments described with reference to FIGS. 1-17 in any combination. For example, the retaining structure 100 may incorporate an ELDL system as outlined above and liners/geomembranes as outlined above. The precast concrete units can be constructed and configured as outlined above. It will be understood that the embodiments described herein have interchangeable features so that the units shown in FIGS. 18-24 can be used or manufactured to form the ELDL system shown in FIGS. 1-17 and vice versa.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1.-26. (canceled)

27. A wall unit for a retaining structure, comprising a foot portion and a wall portion, wherein the wall portion is inclined with respect to the foot portion, so that it extends over the foot portion.

28. The wall unit of claim 27, wherein the wall portion is inclined with respect to the foot portion so that an acute angle is formed between the wall portion and the foot portion.

29. The wall unit of claim 27, wherein the wall portion extends upwardly from one end of the foot portion.

30. The wall unit of claim 27, wherein the wall portion is thicker at a lower end thereof than an upper end thereof, wherein the lower end is closer to the foot portion than the upper end.

31. The wall unit of claim 27, wherein the foot portion comprises an upper surface, which slopes downwardly as it extends away from the wall portion.

32. The wall unit of claim 27, wherein an innermost end of the foot portion forms a toe portion arranged to engage with a floor of the retaining structure.

33. The wall unit of claim 27, comprising an anchorage point configured to receive a tendon.

34. The wall unit of claim 33, wherein the anchorage point is located proximate to a lower end of the wall portion, such that the tendon extends through the foot portion and/or a floor of the retaining structure.

35. The wall unit of claim 33, wherein the anchorage point located proximate to an upper end of the wall portion, so that the tendon extends through a roof of the retaining structure.

36. The wall unit of claim 27, wherein the wall portion and the foot portion are integrally formed, preferably of precast concrete.

37. A corner unit for a retaining structure, comprising:
two wall units;
wherein each of the two wall units comprises a foot portion and a wall portion, the wall portion being inclined with respect to the foot portion so that it extends over the foot portion.

38. The corner unit of claim 37, comprising a first wall arranged to engage with a first of the two wall units, and a second wall arranged to engage with a second of the two wall units.

39. The corner unit of claim 38, wherein the first wall extends substantially orthogonally from the second wall.

40. The corner unit of claim 38, wherein the first wall and second wall reduce in thickness from a lower end to an upper end thereof, wherein an angle of taper corresponds to an inclination of the wall portion of the wall units with respect to the foot portion of the wall units.

41. The corner unit of claim 37, further comprising an anchorage point configured to receive a tendon.

42. A retaining structure, comprising a wall unit, the wall unit comprising a foot portion and a wall portion, the wall portion being inclined with respect to the foot portion so that it extends over the foot portion.

43. The retaining structure of claim 42, comprising at least two adjacent sidewalls, each sidewall comprising a plurality of wall units, and a corner unit adapted to engage with two wall units, comprising a foot portion and a wall portion, wherein the wall portion is inclined with respect to the foot portion so that it extends over the foot portion, disposed between the adjacent sidewalls.

44. The retaining structure of claim 42, comprising a pair of opposing sidewalls, each sidewall comprising a plurality of wall units, and a floor extending therebetween, wherein the floor is comprised of a plurality of preformed floor units.

45. The retaining structure of claim 44, comprising a tendon extending from a wall unit of a first of the opposing sidewalls, through the floor, and to a corresponding wall unit of a second of the opposing sidewalls or an internal dividing wall of the retaining structure,
wherein the tendon is operable to be tightened once installed.

46. The retaining structure of claim 42, comprising a pair of opposing sidewalls, each sidewall comprising a plurality of wall units, and a roof extending between the pair of opposing sidewalls.

47. The retaining structure of claim 46, comprising a plurality of elongate beams, wherein each end of the beam comprises an engagement portion adapted to engage one of the wall units or an internal dividing wall of the retaining structure, wherein a pair of adjacent beams is adapted to retain a roof unit therebetween.

48. The retaining structure of claim 46, comprising a tendon extending from a wall unit of a first of the opposing sidewalls, through the roof, and to a corresponding wall unit of a second of the opposing sidewalls.

49. The retaining structure of claim 48, comprising a roof screed disposed above the beams and roof units, wherein the tendon extends through the screed and the screed retains the tendon in an at least partially curved configuration.

50. The retaining structure of claim 42, wherein the retaining structure is one of a fluid retaining structure, a service reservoir, a tank, a bridge abutment, an aggregate store, a retaining wall, a blast wall, an embankment or a superstructure.

51. A retaining structure comprising:
a pair of opposing sidewalls, each sidewall comprising a plurality of wall units, and
a floor extending between the opposing sidewalls,
wherein the retaining structure further comprises a tendon extending from a first wall unit of a first of the opposing sidewalls, through the floor, and to a corresponding second wall unit of a second of the opposing sidewalls, the tendon being operable to be tightened once installed so as to restrain the first and second wall units and the floor.

52. A method of constructing a retaining structure comprising:
forming a pair of opposing sidewalls from a plurality of wall units,
disposing a floor between the opposing sidewalls, and
tightening a tendon extending from a first wall unit of a first of the opposing sidewalls, through the floor, and to a corresponding second wall unit of a second of the opposing sidewalls.
